(19) United States
(12) Patent Application Publication
(10) Pub. No.: US 2024/0385460 A1
(43) Pub. Date: Nov. 21, 2024

(54) HOLOGRAPHIC GRISM AS DISPERSIVE ELEMENT IN RAMAN SPECTROGRAPHS

(71) Applicant: Thermo Electron Scientific Instruments LLC, Madison, WI (US)

(72) Inventors: Theodore Wiley, Monticello, WI (US); Francis Deck, Madison, WI (US); Julian Irwin, Madison, WI (US); Huaning Wang, Madison, WI (US)

(73) Assignee: Thermo Electron Scientific Instruments LLC, Madison, WI (US)

(21) Appl. No.: 18/199,723

(22) Filed: May 19, 2023

(51) Int. Cl. G02B 27/42; G01J 3/44; G02B 5/18; G02B 17/08; G02B 27/30

(52) U.S. Cl. CPC G02B 27/4244; G01J 3/44; G02B 5/1814; G02B 17/0876; G02B 27/30

(57) ABSTRACT

Apparatus can include an input aperture configured to provide an input beam, primary optics configured to collimate the input beam, a grism situated to receive the collimated input beam and to produce a wavelength dispersed beam, and secondary optics configured to receive and direct the wavelength dispersed beam to a detector. Primary optics can include a primary reflector including an off-axis parabolic mirror, wherein the off-axis parabolic mirror is configured to produce the collimated input beam. Secondary optics can include a first secondary reflector and a second secondary reflector, wherein the first secondary reflector is situated to receive and reflect the wavelength dispersed beam to the second secondary reflector and the second secondary reflector is situated to receive and direct the wavelength dispersed beam to the detector.

### FIELD

This field is spectrometry, and more particularly spectrographs and Raman spectrometry.

### BACKGROUND

Spectrographs are (sometimes referred to as spectrometers) are common instruments used to measure the properties of input light across the component wavelengths of the input light, e.g., the intensity of the light at some or all of the component wavelengths of the input light. They are particularly useful in the fields of material and chemical analysis, where light of different types (infrared, visible, and/or ultraviolet) may be directed onto a sample, and the resulting light reflected by, emitted by, scattered by, and/or transmitted through the sample can then be supplied to and analyzed by the spectrograph. The resulting readings can provide information about the properties of the sample.

However, in many applications, spectrographs include spectral separation units (such as monochromators) with limited wavelength separation characteristics and/or suffer from attenuated signal production. In addition, the spectral separation units in spectrographs, such as reflective gratings, degrade over time and are impossible to clean due to being very delicate. Spectral separation units in spectrographs are a consumable that are periodically replaced in spectrographs. Thus, a need remains for improved spectrographs that can address these drawbacks.

### SUMMARY

Disclosed examples use holographic grating prisms (or grisms) in spectrograph spectral separation units. The inclusion of grisms can lead to increased signal collection by the instrument due to improved light throughput allowed by the grism. By using grisms, the spectral separation units can also allow the instrument to retain flexibility in excitation wavelength due to the property of grisms providing dispersion without deflection. By using the grisms, the spectral separation units present a durable glass surface to the environment which can enable cleaning of the element, alleviating the need to periodically replace the spectral separation unit found in a spectrometer. Representative spectrographs (including the DXR/triplet line of spectrographs and Raman detection apparatus produces by Thermo Scientific) can have reflection-based ruled gratings replaced with holographic grisms leading to improved instrument efficiency while retaining modularity in detectable spectra.

The foregoing and other objects, features, and advantages of the disclosed technology will become more apparent from the following detailed description, which proceeds with reference to the accompanying figures.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a schematic perspective view of a Czerny-Turner-type monochromator.

FIG. 2 is a schematic perspective view of another monochromator arrangement.

FIG. 3A-3B are plan and perspective views of another spectral detection unit.

FIG. 4 is a schematic plan view of a spectral detection unit using a grating prism (grism).

FIG. 5 is a plan view of a grism that does not include an input prism.

FIG. 6 is a flowchart of an example method of adapting grism selection based on excitation wavelength.

### DETAILED DESCRIPTION

### Introduction to Spectrograph Technology

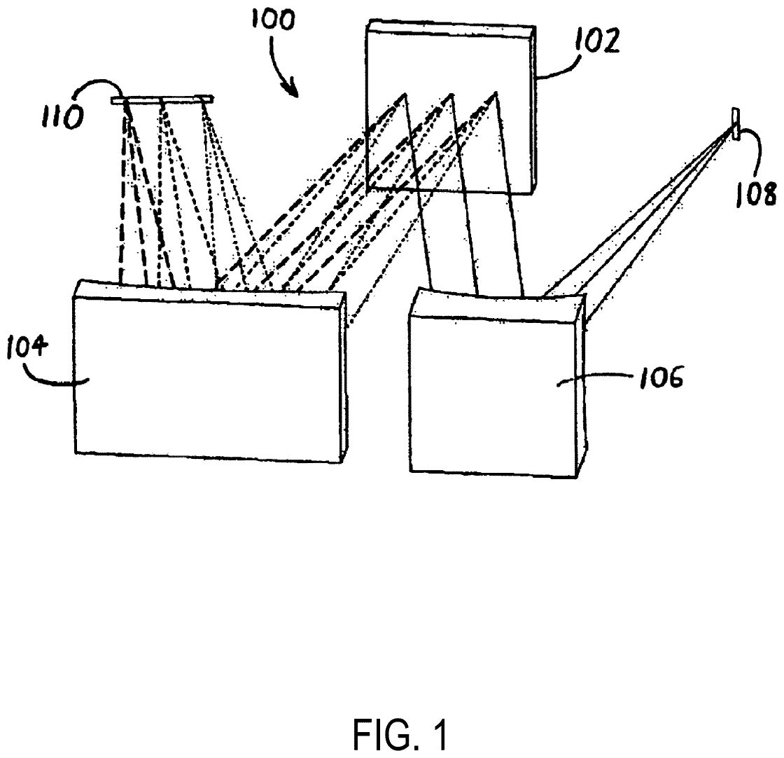

A common spectrograph design incorporates a monochromator, a device which separates the input light into its component wavelengths, and a detector (usually a photosensor) which measures light intensity at one or more of the wavelengths. FIG. 1 shows one type of monochromator 100, known as a Czerny-Turner monochromator. The monochromator 100 includes a reflective diffraction grating 102, a primary reflector 106 (a mirror, usually spherical or toroidal, supplying the grating 102 with light), and a secondary reflector 104 (a mirror, usually spherical or toroidal, receiving light from the grating 102). An aperture 108 (shown as a narrow slit, though it could be a pinhole instead) at the focus of the concave primary reflector 106 admits input light (e.g., light reflected or emitted by a sample to be analyzed), with the input light then being incident on the primary reflector 106. The primary reflector 106 collimates the light rays within the beam (reorients the rays into parallel paths focused at infinity), with the collimated beam then being directed to the diffraction grating 102. The grating 102 has an array of fine slits (not shown) arrayed across its face. While termed “slits,” these are usually not slits in the sense that they define apertures across the face of the grating 102; rather, the slit array is generally defined by an array of angled surfaces, e.g., the face of the grating 102 may have a sawtooth or sinusoidal profile on a microscopic or near-microscopic scale. The grating 102 reflects light at different wavelengths at different angles, with FIG. 1 depicting rays at three different wavelengths by phantom/dashed lines having dashes of different sizes and spacings. All or most of the reflected light is then received by the concave secondary reflector 104, which focuses the light at each wavelength onto some output element such as an array detector 110 (e.g., an array of photosensitive elements) which measures light intensity at each of the component wavelengths. Thus, a user obtains a measurement of light intensity across the range of wavelengths incident on the detector 110, and the identities of these wavelengths may be calculated with knowledge of the characteristics of the primary reflector 106, grating 102, and secondary reflector 104 (and the location of the readings across the detector 110).

The arrangement of FIG. 1 can suffer from aberrations common to all non-ideal optical systems, such as coma, astigmatism, and spherical aberration. These aberrations result in distortion of the image on the detector 110 and therefore limit the resolution of the spectrograph. For example, spherical aberration, an aberration inherent in optical elements having spherical surfaces (such as in the spherical reflectors 104 and 106), can also result in some rays being out-of-focus at the detector 110 and can hinder resolution. More significantly, coma (an aberration caused by the reflection of light rays at non-perpendicular angles, wherein the rays elongate in the plane of the incident and reflected rays) cause the different-wavelength rays to at least partially overlap on the detector 110 rather than resting in separate bands, thereby affecting the accuracy of the intensity readings. Careful choice and alignment of the primary and secondary reflectors 106 and 104 can reduce coma across a range of wavelengths, with coma correction being optimal at a selected “design wavelength” and decreasing at wavelengths away from the design wavelength. As a result, the arrangement of FIG. 1 is practically limited for use at its design wavelength and for surrounding wavelengths. If a different range of wavelengths is desired, one must change the angle of the grating 102, or use a different grating 102. But these would in turn require reorientation of the primary and secondary reflectors 106 and 104, as well as reorientation and/or relocation of the detector 110, in order to reduce aberration about the new design wavelength. In practice, this is difficult and/or expensive to accomplish because of the complexity in situating the various optical elements (which must be rather precisely placed) and the need for the various positioners/actuators and controls required to accomplish placement of the optical elements.

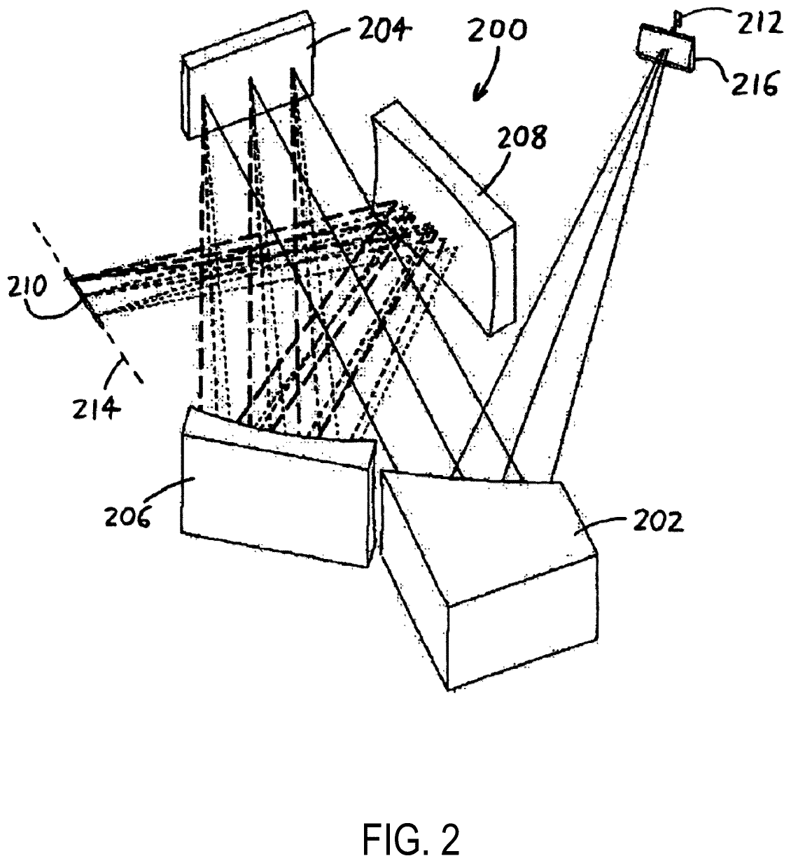

An improved monochromator 200 is depicted in FIG. 2 which includes a primary reflector 202, a reflective diffraction grating 204, a first secondary reflector 206, a second secondary reflector 208, and a photosensitive detector 210 (preferably an array detector including a series of photosensitive elements situated along a focal plane 214). The primary reflector 202 is aligned to receive input light (preferably from an input aperture 212 formed as a slit or hole) and reflect the input light in collimated form to the reflective diffraction grating 204. The grating 204 reflects the different component wavelengths of the collimated input light at different respective angles (with three different wavelengths again being depicted by dashed lines having different dash densities). The component wavelengths are then received by a first secondary reflector 206 and reflected to a second secondary reflector 208, which in turn receives the component wavelengths and reflects them onto different respective regions of the detector 210, with each of the secondary reflectors 206 and 208 serving to partially focus the component wavelengths onto the detector 210.

The primary reflector 202 is an off-axis parabolic mirror, i.e., a section of a parabolic mirror oriented to receive the input light from a direction off the axis of the parabola, since such a mirror can provide effectively ideal collimation of the input light from the aperture 212, with no or minimal aberration. Thus, whereas prior arrangements using spherical mirrors and similar elements introduced aberrations which were then anamorphically magnified by the reflective diffraction grating, with the monochromator 200 the collimated input light enters and exits the diffraction reflective grating 204 with no or little aberration. The secondary reflectors 206 and 208, which are preferably spherical or toroidal mirrors, are then chosen to both (1) cooperate to focus the diffracted component wavelengths of the input light onto the detector 210, and (2) have the second secondary reflector 208 provide corrections to the component wavelengths which at least substantially cancel any aberrations introduced by the first secondary reflector 206. The detector 210 is then situated along a focal plane 214 which is oriented to accommodate the focal points of the reflected component wavelengths of the input light. Since the input light is provided to the grating 204 with no or little aberration (and thus the grating 204 provides no or little magnification of such aberration), and since the secondary reflectors 206 and 208 at least substantially cancel any aberration introduced while focusing the component wavelengths onto the focal plane 214, superior wavelength resolution results.

An interesting characteristic of the monochromator 200 is that the rays of input light and its component wavelengths will cross in the “wavelength plane” (the plane along which the elements are located and wherein the wavelengths of the input light are separated), unless the beams are redirected/folded out of the wavelength plane by the use of additional optical elements (which then increase size and cost, and also potentially introduce further aberration). In particular, the light received by and reflected from the reflective diffraction grating 204 (from the primary reflector 202 and to the first secondary reflector 206) intersects the paths of the light received by and reflected from the second secondary reflector 208 (from the first secondary reflector 206 and to the detector 210).

When a change in the design wavelength is desired, it is preferred that rather than reorienting the reflective diffraction grating 204 (and correspondingly reorienting/relocating any of the other optical elements and/or the detector 210), the grating 204 should simply be replaced with a different reflective diffraction grating 204 having the desired design wavelength. This could be done by providing the reflective diffraction grating 204 in a frame which allows manual grating removal and replacement, or different reflective diffraction gratings 204 could be provided on a motorized track or wheel which can be translated and/or rotated to situate a desired grating 204 in place.

A lens 216 (here depicted as a cylindrical lens) may also be provided between the input aperture 212 and the primary reflector 202 to reduce astigmatism in the “non-wavelength” plane perpendicular to the plane in which the light wavelengths are separated, i.e., to concentrate the light in the wavelength plane. This allows the detector 210 to be made with lesser height in planes perpendicular to the wavelength plane (with the detector 210 in FIG. 2 having low height in a vertical direction), which can be beneficial for space reduction, as well as for reducing detector noise (e.g., by providing lesser area for impingement by cosmic rays, which can generate spurious detector readings). The lens 216 allows optical elements such as the primary reflector 202, reflective diffraction grating 204, first secondary reflector 206, and second secondary reflector 208 to also be provided with lesser vertical height (and thus an overall “thin” configuration for the monochromator 200).

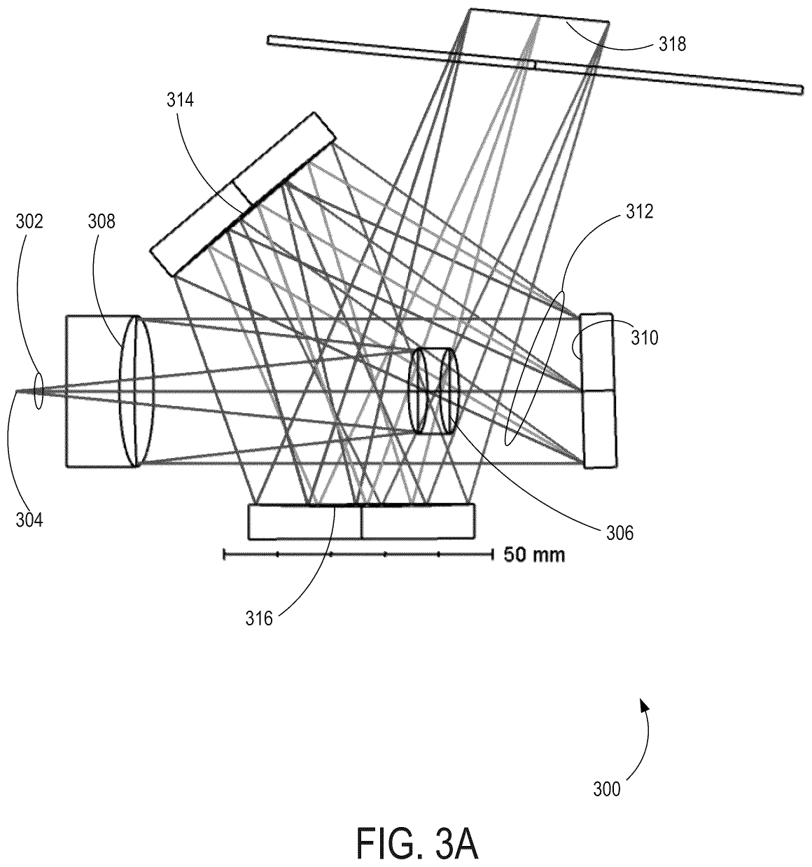

FIGS. 3A-3B show another example of a spectral detection unit 300 of a spectrograph. A source beam 302 is directed through an aperture 304 and reflected by a first primary reflector 306 and then by a second primary reflector 308 to a reflective diffraction grating 310. As shown, the first primary reflector 306 is planar and the second primary reflector 308 is off-axis parabolic. The source beam 302 becomes collimated after reflection off the second primary reflector 308. The reflective diffraction grating 310 disperses the source beam 302 according to wavelength to form a dispersed beam 312, thereby forming collimated component beams at the dispersed wavelengths. A first secondary reflector 314 receives the dispersed beam 312 and directs the dispersed beam 312 to a second secondary reflector 316. The second secondary reflector directs the dispersed beam 312 to a detector 318. The first and second secondary reflectors 314, 316 can both be non-planar, e.g., spherical and toroidal, to focus the component beams of the dispersed beam 312 at the detector 318. The component beams are focused at different positions on the detector 318 based on the wavelength content of the source beam 302 and the characteristics of the reflective diffraction grating 310, which can be swappable in many examples with alternative grating with different characteristic angles of diffraction. The prescriptions of the first and second secondary reflectors 314, 316 can be configured to correct for various optical aberrations, including those introduced by other optical components of the spectral detection unit 300, such as the first and/or second primary reflectors 306, 308.

### Examples of the Disclosed Technology

Representative spectral detection units, spectrographs, microscopes, and other systems include a grism as a dispersive element. Suitable grisms can replace reflection gratings in existing systems, such as those described with respect to FIGS. 1-3B. By using a grism to disperse the light of an input beam, first order diffraction light can be more efficiently collected, thereby allowing increased optical throughput and detection of the dispersed input light. Further, a grism allows precise control over the relationship between input and output beam paths to and from the grism, allowing an increase in modularity for detecting various excitation wavelengths or, in some examples, removing the grism for direct imaging. Additionally, the surfaces of the grism are glass, rather than a delicate ruled surface as in a ruled reflective grating, enabling ease of maintenance in the field.

Because the angle of diffraction from reflection gratings depends on the wavelength of the input light, the detection characteristics of spectral detection units employing reflection gratings can be more difficult to adjust. That is, as an excitation wavelength is changed, an associated change in diffracted angle of the dispersed light can require carefully aligned rotation of the reflection grating or swapping to alternative gratings with specially designed baseplates supporting different angles. Moreover, a reflection grating is often configured at or near normal incidence to the input beam which can make imaging more difficult where a mirror is swapped in place of the reflective grating.

Angle of diffraction from a transmission grating alone is approximately invariant in response to grating rotation. This can limit the capabilities of spectral detection units employing transmission gratings because without rotation of the grating as a degree of freedom, detection may be confined to a specific excitation wavelength or narrow wavelength range. However, for a selected excitation wavelength, a grism can provide an output path of a selected wavelength of the beam from the grism that is collinear or parallel (or at a selected angle) with respect to an input path of the input beam to the grism. Thus, by using a grism, the light of the input beam can be spectrally dispersed without reflective grating type dependence on the angle of diffraction, but also the direction of the output beam can be controlled without being constrained by transmission grating type invariance to grating rotation angle. This can allow additional grisms tuned to different excitation wavelengths to be conveniently swapped into the same position as the grism, e.g., with a wheel, cartridge, etc. For grism arrangements producing an output beam at a selected wavelength collinear with the input beam, the grisms can be removed (e.g., with a blank wheel slot) and an image of the aperture plane can be detected without adjusting the optical system or detector. Alternatively, other optical components can be positioned along the input beam or output beam path for alternative imaging effect again without necessarily adjusting positioning of other optical system components of the spectral detection unit.

A grism can be defined as an optical component that includes at least one prism and a diffraction grating arranged relative to each other. In many examples, grism arrangements include a transmissive diffraction grating interposed between two prisms. In representative examples, a grism includes two prisms with each being affixed or secured in relation to a respective opposing face of the grating, e.g., with an adhesive or clamp. In some examples, a grism can be formed as a unitary piece. In some examples, one or both prisms can be spaced apart from the transmission grating in a fixed relation, e.g., by a small gap of air or other medium. In further examples, a grism can include a single prism arranged on the output face of the grating. In many examples, a first prism can be situated to deflect an input beam at a small angle to an optical axis of the input beam and the second prism can be situated to deflect the output beam at similar angle back towards the input optical axis. The dimensions of the input and output prisms, such as thickness and wedge angles, can be configured so that for a selected wavelength of interest (such as a Raman excitation wavelength) an input optical axis to the grism is approximately collinear with an output optical axis from the grism. In such a configuration, an incident collimated beam at the selected wavelength of interest propagates along a portion of approximately the same path in the presence or absence of the grism. In the absence of the grism, other wavelengths of the incident collimated beam that are different from the selected wavelength of interest also propagate along the portion of the path.

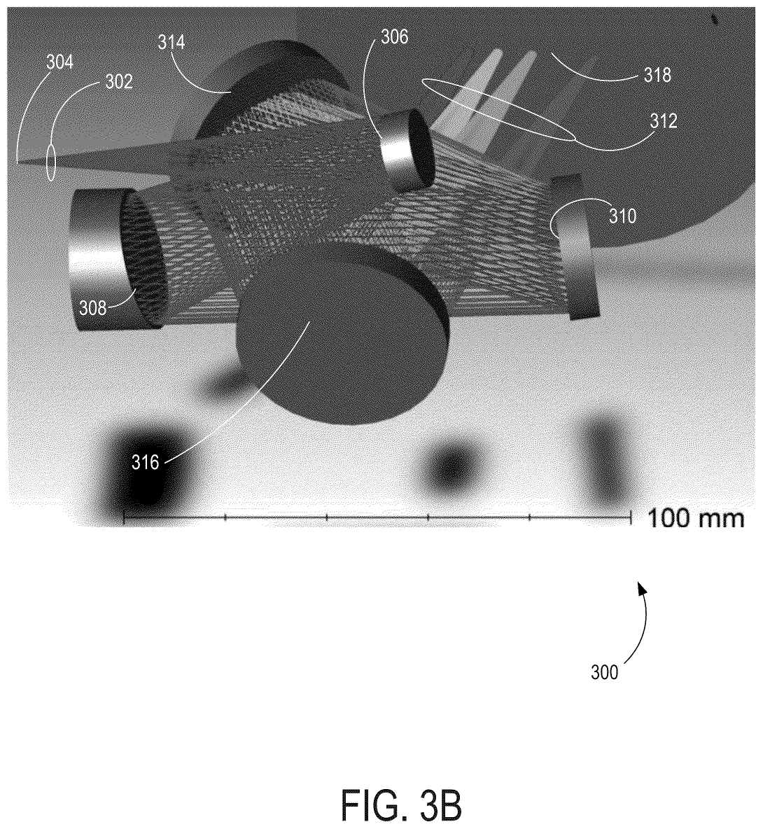

FIG. 4 is an example spectral detection unit 400 that can be part of a spectrograph or microscope, such as a Raman spectrograph or microscope. The unit 400 can be configured to direct a source beam 402 through an aperture 404, such as a pinhole or rectangular slit. The source beam 402 is reflected by a first primary reflector 406 and then by a second primary reflector 408 to form a collimated input beam 409 that is directed to a grism 410 along an input axis 411. As shown, the first primary reflector 406 is planar, spherical, cylindrical, or toroidal, and the second primary reflector 408 is off-axis parabolic. The grism 410 disperses the input beam 409 according to wavelength to form a dispersed output beam 412 with collimated component beams 413a, 413b, 413c at the dispersed wavelengths. A first secondary reflector 414 receives the dispersed beam 412 and directs the dispersed beam 412 to a second secondary reflector 416. The second secondary reflector 416 directs the dispersed beam 412 to a detector 418. The first and second secondary reflectors 414, 416 are both non-planar, e.g., spherical and toroidal, to focus the component beams 413a-413c of the dispersed beam 412 at the detector 418. The component beams 413a-413c are focused at different positions on the detector 418 based on the wavelength content of the source beam 402 and the groove density, prism input and output angles, and the input and output prism material refractive indices of the grism 410. The prescriptions of the first and second secondary reflectors 414, 416 can be configured to correct for various optical aberrations, including those introduced by other optical components of the spectral detection unit 400, such as the first and/or second primary reflectors 406, 408.

The grism 410 can include an input prism 420, a transmissive grating 422, and an output prism 424. The transmissive grating 422 can be a volume phase holographic transmission grating. The grism 410 can be configured to diffract and direct light based on a wavelength of the source beam 402. For example, the incident beam 409 can be received by the input prism 420 and refracted along a first prism axis 426 at an angle proportional to the product of the sine of the angle of incidence and the ratio of the refractive indices of the two materials. The transmissive grating 422 receives the refracted beam and produces a diffracted beam that is immediately received by the output prism 424. As the beam disperses based on the grating groove density and angle of incidence of the transmissive grating 422, the second prism directs the light generally along a second prism axis 428. The second prism axis 428 can align with a diffraction path that is associated with a characteristic wavelength, e.g., a wavelength corresponding to the wavelength of the component beam 413b. The output prism 424 then refracts the diffracted beam so that the dispersed beam 412 is directed generally along an output beam axis 430, which can be aligned with the path of the component beam 413b. In many examples, the characteristic wavelength and associated axes are often centered or approximately centered on centers of various optical components such as lenses, mirrors, and/or the detector 418.

In some examples, the grism 410 can be affixed or detachably secured in a selected slot or position of a grism selection mechanism 432. For example, the grism selection mechanism 432 can include a slotted wheel rotatable about an axis 434 so that the grism 410 can be removed from the path of the collimated input beam 409. In some examples, one or more additional grisms, such as an alternative grism 436, can be rotated into the same or similar position along the path of the collimated input beam 409. In further examples, the grism selection mechanism 432 can include a linear slide instead of, or in addition to, a rotatable wheel. A linear slide can include one or more alternative grisms 438, e.g., in different slots arranged along a linear axis 440 of a slidable cartridge. The slidable cartridge can be movably secured in a channeled support to slide the arranged grisms along the linear axis 440 into a suitable position with respect to the input beam 409. Different grisms of the grism selection mechanism 432 can be aligned and secured into position, rotatably and/or linearly, for use in the spectral detection unit 400 in various ways, such as with clamps, detents, latches, pawls, friction, etc. The grism 436 and additional grisms can be configured with different diffraction characteristics, e.g., associated with characteristic wavelengths different from the characteristic wavelength of the grism 410. In selected examples, the grism selection mechanism 432 can move the grism 410 so that the collimated input beam 409 can propagate without interacting with a grism. In further examples, other components can be moved into position of the collimated input beam 409, such as filters, wedge prisms, polarizing filters, etc.

By employing grisms, spectrographs can avoid losses in the range of 30-40% associated with ruled reflection gratings. In particular, applications where photon budget is limited, such as Raman spectroscopy, can benefit greatly. The grism can allow a chief ray of an input beam to be un-deviated from the initial beam path, thereby travelling in a straight line from a primary mirror to a secondary mirror. The grism can enable a 10-20% higher sensitivity in example spectrometer and microscope systems. Moreover, incorporation of grisms can enable the ability to switch the spectral selectivity of the spectral selection unit without the need for any optical realignment. In addition, disclosed grism configurations can be applied to future spectrometer designs, eliminating the need for difficult angles built into their mechanical layouts. Also, the robustness of the grism surfaces can enable easy maintenance and cleaning that would otherwise lead to replacement in the case of reflection gratings.

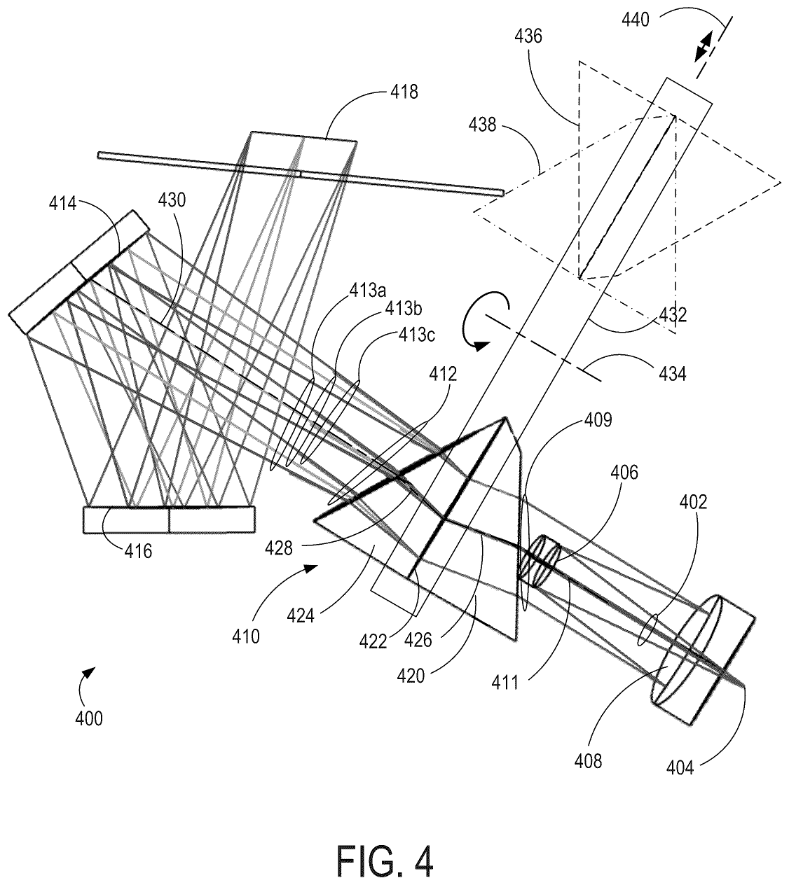

FIG. 5 is an example grism arrangement 500 includes a grism 501 having a transmissive grating 502 and an output prism 504. A collimated input beam can be directed along an input axis 506 and be received by the transmissive grating 502. The collimated input beam 506 is diffracted by the transmission grating at an angle of diffraction described by the grating equation, arcsin ((nλ/d)±sin α)=β, where n is an integer specifying the order of diffraction, A is the wavelength of the incident light, d is the groove density of the grating, α is the angle of incidence, and β is the angle of diffraction. The output prism 504 refracts the dispersed beam at an angle of refraction θ₂ given by, sin θ₂=(n₁/n₂) sin θ₁, where n₁ and n₂ are the refractive indices of the grating and the prism and θ₁ is the angle of incidence to the prism. The cut angle of the prism and material can be chosen to give a preferred angle of refraction θ₂ to direct at least a characteristic wavelength of a dispersed output beam to propagate along an output axis 508. The output axis 508 is generally arranged at a non-zero angle with respect to the input axis 506. A grism selector mechanism (e.g., similar to the mechanism 432) can also be situated to swap the grism 501 so that a separate grism or other optical component (or nothing) becomes situated in the path of the collimated input beam. In some examples, the grism selector mechanism is situated to rotate a wheel in a plane perpendicular to the output axis 508 or another plane.

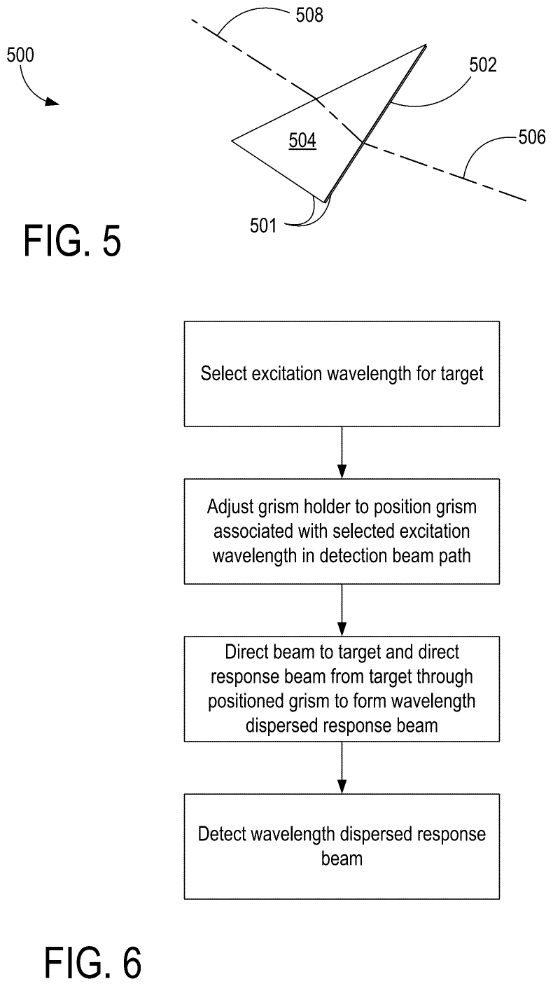

FIG. 6 is an example method 600 of target inspection with a spectrograph or microscope. At 602, an excitation wavelength is selected for a target. At 604, a grism holder is adjusted, e.g., through rotation, to position a grism associated with the excitation wavelength in a detection beam path. At 606, a beam is directed to the target and response light from the target is directed through the positioned grism to form a wavelength dispersed response beam. At 608, the wavelength dispersed response beam is detected with a photodetector.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatuses are referred to as “lowest”, “best”, “minimum,” or the like. It will be appreciated that such descriptions are intended to indicate that a selection among many used functional alternatives can be made, and such selections need not be better, smaller, or otherwise preferable to other selections.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

### Additional Representative Embodiments

Clause 1 is an apparatus, comprising an input aperture configured to provide an input beam; primary optics configured to collimate the input beam; a grism situated to receive the collimated input beam and to produce a wavelength dispersed beam; and secondary optics configured to receive and direct the wavelength dispersed beam to a detector.

Clause 2 includes the subject matter of Clause 1, and further specifies that the grism comprises an input prism, an output prism, and a transmissive volume phase holographic diffraction grating interposed between the input prism and output prism.

Clause 3 includes the subject matter of any of Clauses 1-2, and further specifies that the primary optics comprise a primary reflector including an off-axis parabolic mirror, wherein the off-axis parabolic mirror is configured to produce the collimated input beam; wherein the secondary optics comprise a first secondary reflector and a second secondary reflector, wherein the first secondary reflector is situated to receive and reflect the wavelength dispersed beam to the second secondary reflector and the second secondary reflector is situated to receive and direct the wavelength dispersed beam to the detector.

Clause 4 includes the subject matter of Clause 3, and further specifies that the primary optics further comprise a first reflector situated to receive the input beam and direct the input beam to the primary reflector.

Clause 5 includes the subject matter of any of Clauses 1-4, further comprising a grism selection mechanism situated to support the grism situated to receive the collimated input beam and to move the grism to an alternative position in which the grism is not situated to receive the collimated input beam.

Clause 6 includes the subject matter of Clause 5, and further specifies that the grism selection mechanism comprises a rotation mechanism configured to rotatably move the grism into and out of a position situated to receive the collimated input beam.

Clause 7 includes the subject matter of Clause 5, and further specifies that the grism selection mechanism comprises a linear slide mechanism configured to move the grism into and out of the position situated to receive the collimated input beam.

Clause 8 includes the subject matter of any of Clauses 5-7, and further specifies that the grism selection mechanism further comprises one or more additional support positions for receiving one or more respective grisms, wherein the one or more additional support positions are configured to be movably positioned to receive the collimated input beam.

Clause 9 includes the subject matter of Clause 8, and further comprises one or more of the respective grisms, wherein at least one of the one or more respective grisms is configured to diffract at a characteristic wavelength different from a characteristic wavelength of the grism.

Clause 10 includes the subject matter of any of Clauses 1-9, and further specifies that the grism is configured, for a characteristic wavelength, to direct the collimated input beam having an input optical axis to form the wavelength dispersed beam having an output optical axis associated with the characteristic wavelength.

Clause 11 includes the subject matter of Clause 10, and further specifies that the input optical axis and output optical axis are parallel or approximately parallel.

Clause 12 includes the subject matter of any of Clauses 10-11, and further specifies that the input optical axis and output optical axis are collinear or approximately collinear.

Clause 13 includes the subject matter of Clauses 10, and further specifies that the input optical axis and output optical axis are at a non-zero angle with respect to each other.

Clause 14 includes the subject matter of any of Clauses 1, 3-9, or 13, and further specifies that the grism comprises an output prism and a transmissive volume phase holographic diffraction grating, wherein the transmissive volume phase holographic diffraction grating is situated to receive the collimated input beam directly from the primary optics.

Clause 15 includes the subject matter of any of Clauses 1-13, and further comprises the detector, wherein the apparatus comprises a spectrograph and the input source comprises a Raman excitation beam.

Clause 16 includes the subject matter of any of Clauses 1-15, and further specifies that the apparatus comprises a microscope.

Clause 17 is a method, comprising directing a probe beam with an excitation wavelength to a target; directing a response beam from the target through a grism to form a wavelength dispersed response beam; directing the wavelength dispersed response beam to a photodetector; and detecting the wavelength dispersed response beam with the photodetector.

Clause 18 includes the subject matter of Clause 17, and further specifies that the grism comprises an input prism, an output prism, and a transmissive diffraction grating interposed between the input prism and output prism.

Clause 19 includes the subject matter of any of Clauses 17-18, and further comprises selecting an excitation wavelength for the target; and adjusting a grism holder to position the grism associated with the selected excitation wavelength to be situated to receive the response beam.

Claim 20 includes the subject matter of any of Clauses 17-19, and further specifies that the directing the response beam from the target through the grism comprises directing the response beam to primary optics, wherein the primary optics comprise a primary reflector including an off-axis parabolic mirror, wherein the off-axis parabolic reflector is configured to produce a collimated input beam incident on the grism; and directing the wavelength dispersed response beam to secondary optics, wherein the secondary optics comprise a first secondary reflector and a second secondary reflector, wherein the first secondary reflector is situated to receive and reflect the wavelength dispersed response beam to the second secondary reflector and the second secondary reflector is situated to receive and direct the wavelength dispersed response beam to the photodetector.

We claim:

1. An apparatus, comprising:
an input aperture configured to provide an input beam;
primary optics configured to collimate the input beam;
a grism situated to receive the collimated input beam and to produce a wavelength dispersed beam; and
secondary optics configured to receive and direct the wavelength dispersed beam to a detector.

2. The apparatus of claim 1, wherein the grism comprises an input prism, an output prism, and a transmissive volume phase holographic diffraction grating interposed between the input prism and output prism.

3. The apparatus of claim 1, wherein the primary optics comprise a primary reflector including an off-axis parabolic mirror, wherein the off-axis parabolic mirror is configured to produce the collimated input beam;
wherein the secondary optics comprise a first secondary reflector and a second secondary reflector, wherein the first secondary reflector is situated to receive and reflect the wavelength dispersed beam to the second secondary reflector and the second secondary reflector is situated to receive and direct the wavelength dispersed beam to the detector.

4. The apparatus of claim 3, wherein the primary optics further comprise a first reflector situated to receive the input beam and direct the input beam to the primary reflector.

5. The apparatus of claim 1, further comprising a grism selection mechanism situated to support the grism situated to receive the collimated input beam and to move the grism to an alternative position in which the grism is not situated to receive the collimated input beam.

6. The apparatus of claim 5, wherein the grism selection mechanism comprises a rotation mechanism configured to rotatably move the grism into and out of a position situated to receive the collimated input beam.

7. The apparatus of claim 5, wherein the grism selection mechanism comprises a linear slide mechanism configured to move the grism into and out of the position situated to receive the collimated input beam.

8. The apparatus of claim 5, wherein the grism selection mechanism further comprises one or more additional support positions for receiving one or more respective grisms, wherein the one or more additional support positions are configured to be movably positioned to receive the collimated input beam.

9. The apparatus of claim 8, further comprising one or more of the respective grisms, wherein at least one of the one or more respective grisms is configured to diffract at a characteristic wavelength different from a characteristic wavelength of the grism.

10. The apparatus of claim 1, wherein the grism is configured, for a characteristic wavelength, to direct the collimated input beam having an input optical axis to form the wavelength dispersed beam having an output optical axis associated with the characteristic wavelength.

11. The apparatus of claim 10, wherein the input optical axis and output optical axis are parallel or approximately parallel.

12. The apparatus of claim 10, wherein the input optical axis and output optical axis are collinear or approximately collinear.

13. The apparatus of claim 10, wherein the input optical axis and output optical axis are at a non-zero angle with respect to each other.

14. The apparatus of claim 1, wherein the grism comprises an output prism and a transmissive volume phase holographic diffraction grating, wherein the transmissive volume phase holographic diffraction grating is situated to receive the collimated input beam directly from the primary optics.

15. The apparatus of claim 1, further comprising the detector, wherein the apparatus comprises a spectrograph and the input source comprises a Raman excitation beam.

16. The apparatus of claim 1, wherein the apparatus comprises a microscope.

17. A method, comprising:
directing a probe beam with an excitation wavelength to a target;
directing a response beam from the target through a grism to form a wavelength dispersed response beam;
directing the wavelength dispersed response beam to a photodetector; and
detecting the wavelength dispersed response beam with the photodetector.

18. The method of claim 17, wherein the grism comprises an input prism, an output prism, and a transmissive diffraction grating interposed between the input prism and output prism.

19. The method of claim 17, further comprising:
selecting an excitation wavelength for the target; and
adjusting a grism holder to position the grism associated with the selected excitation wavelength to be situated to receive the response beam.

20. The method of claim 17, wherein the directing the response beam from the target through the grism comprises:
directing the response beam to primary optics, wherein the primary optics comprise a primary reflector including an off-axis parabolic mirror, wherein the off-axis parabolic reflector is configured to produce a collimated input beam incident on the grism; and
directing the wavelength dispersed response beam to secondary optics, wherein the secondary optics comprise a first secondary reflector and a second secondary reflector, wherein the first secondary reflector is situated to receive and reflect the wavelength dispersed response beam to the second secondary reflector and the second secondary reflector is situated to receive and direct the wavelength dispersed response beam to the photodetector.
